(19) United States
(12) Patent Application Publication
(10) Pub. No.: US 2017/0255319 A1
(43) Pub. Date: Sep. 7, 2017

(54) PEN LOCATION DETECTION

(71) Applicant: Microsoft Technology Licensing, LLC, Redmond, WA (US)

(72) Inventors: Amil WINEBRAND, Petach-Tikva (IL); Michael Orlovsky, Rehovot (IL)

(21) Appl. No.: 15/062,129

(22) Filed: Mar. 6, 2016

(51) Int. Cl. G06F 3/041; G06F 3/0354; G06F 3/044

(52) U.S. Cl. CPC G06F 3/0416; G06F 3/044; G06F 3/03545

(57) ABSTRACT

A method including receiving an output signal from a grid based digitizer sensor to detect outputs from junctions of the sensor, identifying, based on the output signal, an area on the sensor likely to include output caused by touch of a passive pen tip, applying a maximum likelihood cost function at points within the area to identify likely coordinates of the passive tip on the digitizer sensor, and selecting most likely coordinates for the location of the passive pen tip, wherein the most likely coordinates are defined based on the output signal in the area and on a pre-defined response function, wherein the response function relates an output signal from a junction to distance of the passive tip from the junction. Related apparatus and methods are also described.

### BACKGROUND

Digitizer sensors are used for touch detection in many Human Interface Devices (HID) such as laptops, track-pads, MP3 players, computer monitors, and smart-phones. Capacitive sensors are one type of digitizer sensors. The capacitive sensor senses positioning and proximity of a conductive object such as a conductive stylus or finger used to interact with the HID. The capacitive sensor is often integrated with an electronic display to form a touch-screen. Capacitive sensors include antennas or lines constructed from different media, such as copper, Indium Tin Oxide (ITO) and printed ink. ITO is typically used to achieve transparency. Some capacitive sensors are grid based and operate to detect either mutual capacitance between electrodes at different junctions in the grid or to detect self-capacitance at lines of the grid.

### SUMMARY

An aspect of some embodiments of the disclosure includes a method for detecting a location of a passive object with a relatively fine conductive tip touching a sensing surface of a grid based digitizer sensor. The object may be a passive stylus, an ink pen, a pencil, a pointer and the like. A passive stylus as defined herein is a stylus or a similarly shaped object including a tip that interacts with a touch screen without the pen emitting a signal. Some non-limiting examples include a pencil, a pen, or a pointer. The tip of the object may be conductive, partially conductive or formed with a dielectric material. A fine tip as defined herein is a tip with a diameter touching the sensor that is less than about 3 mm or close to or smaller than a pitch of the grid. An output signal of a touch screen due to presence of a fine tip of a passive stylus is likely to be weak, relatively close to background noise, and to be detectable from background noise only a small number of grid junctions away from the location of touch.

The term fine tip is not an accurate definition, but is intended to differentiate from a finger or a wide-tip capacitive stylus touching a sensor, where the finger touch area has an approximate diameter of at least 3-4 mm.

According to some exemplary embodiments, coordinates of a conductive tip are determined based on output detected on a plurality of junctions of the digitizer sensor and based on a pre-defined response function relating output from a junction to distance, and optionally azimuth, of the conductive tip from that junction. The response function is typically determined based on measured values. Typically, maximum likelihood criteria are applied to determine probability that the tip is located at a certain location. A probability above a pre-defined threshold may be included in determining the most likely location of the conductive tip. In some embodiments, this method provides for tracking location of a conductive tip with sub-grid resolution. Optionally, the resolution can reach up to 0.1, 0.05, 0.025 and even 0.01 of a distance between junctions.

Unless otherwise defined, all technical and/or scientific terms used herein have the same meaning as commonly understood by one of ordinary skill in the art. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 is a simplified illustration of a grid-based sensor and a fine-tip passive pen;

FIG. 2A is an exemplary graph of measured relative effects from a junction center of grid-based sensor as a function of distance and azimuth of a conductive tip from the junction according to an example embodiment of the disclosure;

FIG. 2B is an exemplary Pearson VII functions shown in two dimensions with different tail shapes in accordance with some exemplary embodiments of the present disclosure;

FIGS. 2C and 2D are illustrations of an estimated average response and a matched filter respectively according to an example embodiment of the disclosure;

FIG. 3 is a simplified flow chart illustration of a method for filtering a list of blobs to reject blobs not caused by a pen, calculate coordinates of a tip of the pen, and report the coordinates, according to an example embodiment of the disclosure;

FIG. 4 is a simplified illustration of junctions in a grid sensor and a location of a tip of a fine-tipped passive pen according to an example embodiment of the disclosure;

FIG. 5 is a simplified illustration of using progressively finer resolution grids to search for likely coordinates of a passive fine-tipped stylus touching a grid sensor according to an example embodiment of the disclosure;

FIG. 6 is a simplified illustration of using a gradient descent optimization method to search for likely coordinates of a passive fine-tipped stylus touching a grid sensor according to an example embodiment of the disclosure; and

FIG. 7 is a simplified flow chart illustration of a method for mapping a relationship between a signal and a location of a pen tip touching a sensing surface of a grid based digitizer sensor according to an example embodiment of the disclosure.

### DETAILED DESCRIPTION

An aspect of the disclosure includes a method for a grid-based sensor to locate a passive pen. Approximate location of the passive pen may be detected based on a mutual capacitive detection method or a self-capacitive detection method. When the pen is placed touching or hovering above the grid-based sensor, amplitude of electric signals transmitted on the grid-based sensor is altered by the proximity of the pen to the sensor. The altered amplitude is typically referred to as the relative effect. A heatmap that maps the detected relative effect at each junction of the grid is used in determining a location of the pen relative to the grid. Typically, the relative effect due to the presence of a fine conductive tip is weak and coordinates of the tip are difficult to calculate with sufficient sub-pixel resolution.

According to embodiments of the present disclosure, a response function that relates the relative effect at a junction to distance and optionally azimuth of a conductive tip from that junction is measured or approximated. Once defined, the response function is applied to improve location detection of a passive pen. Typically, the response function is modeled as a peak function. Optionally, the function is modeled as a 2D extension of a Pearson VII function with fitted parameters. The parameters may typically be sensitive to size of the tip, shape of the tip, conductive material of the tip as well as properties of the digitizer sensor and touch screen. Typically, the response function is defined for a specified touch screen and for a specified tip. More than one response function may be stored on a computing device to accommodate detecting different types of passive pens, e.g. a pencil, an ink pen, a passive stylus on the digitizer sensor.

According to some exemplary embodiments, the method is applied on relatively small blobs detected on the heatmap. A blob is defined as a group of two or more adjacent junctions associated with a relative effect exceeding a defined threshold. Larger blobs typically include enough information for detecting touch location using known methods. Prior to applying the response function to locate coordinates of the passive pen, the heatmap is examined to identify candidate blobs for the passive pen. Typically, only single junction candidates or small blobs extending over 1-2 pixels in one of the axes are selected as candidate blobs for a passive conductive tip. Since the relative effect of the conductive tip is expected to be weak, filtering, e.g. matched filtering may be applied on raw data to improve detection of candidate blobs.

In some exemplary embodiments, the heatmap is scanned along one axis with a matched filter. The matched filter will typically be a peak, e.g. a negative peak, optionally spread over several junctions, e.g. 5 junctions Amplitude at each junction of the matched filter may be defined based on the measured or estimated response function. Optionally, the amplitudes may represent an average amplitude for a plurality of possible pen locations around a junction.

Blobs including less than a defined number of junctions, e.g. less than 3 junctions along each axis of the digitizer sensor may be selected as candidate blobs for passive pen interaction.

According to some exemplary embodiments, for each candidate blob, a junction in the blob exhibiting peak relative effect is selected and eight junctions surrounding the peak are also selected. Based on this selection, the response function is applied to search for a most likely location of the passive conductive tip in the area defined by the nine junctions. Typically, maximum likelihood cost criteria are applied. In some exemplary embodiments, a gradient descent approach is applied to find a minimum in a log likelihood cost function. In other exemplary embodiments, a multiple grid resolution approach may be applied. In the multiple grid resolution approach, the area defined by the 9 junctions is first divided into a coarse grid and the log likelihood cost function is calculated for each grid point of the coarse grid. Based on the results, a portion of the grid is selected and a finer grid is iteratively defined around the selected portion. The number of iterations may typically be defined by the resolution desired.

In some embodiments, when there is no change in the cost function between iterations, or when the change in the cost function between iterations is smaller than a threshold, convergence is assumed and iterating is stopped. When amplitude of the minimum of the cost function reaches below a defined threshold, coordinates of the conductive tip are defined and optionally reported to a host.

The term “pen” in all its forms is used throughout the present specification and claims interchangeably with the term “stylus” and its corresponding forms.

The term “junction” in all its forms is used throughout the present specification and claims interchangeably with the term “grid junction” and its corresponding forms.

The term “tip” in all its forms is used throughout the present specification and claims to mean a portion of a handheld device that touches the digitizer sensing surface during interaction with the digitizer sensor, e.g. a writing tip of a pen.

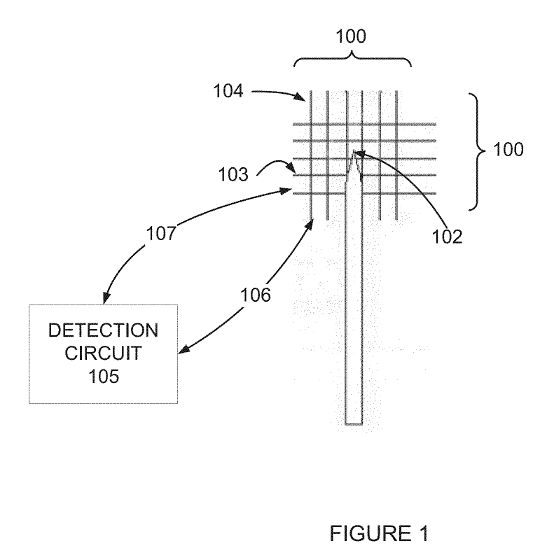

Reference is now made to FIG. 1, which is a simplified illustration of a grid-based sensor 100 and a fine-tip passive pen 101.

FIG. 1 depicts the grid-based sensor 100 having X lines 103 and Y lines 104. In some exemplary embodiments, sensor 100 is a capacitive based sensor that can sense input from finger touch and other conductive objects such as a passive pen. Typically, a mutual capacitive detection method is applied to identify location of a conductive object on the sensor. Alternatively or additionally, a self-capacitive detection method may be applied. Typically, a heatmap that maps the relative effect at each junction is defined from output from sensor 100. Blobs are typically identified from the heatmap.

It is noted that in some embodiments one or the other of the X lines 103 and Y lines 104 is an active set of lines carrying an electric signal, and the other one of the X lines 103 and Y lines 104 is a passive set of lines collecting an electric signal and transferring the electric signal to a detection circuit 105 for analyzing the electric signal and locating a most-likely location of a tip 102 of the passive pen 101. The detection circuit is typically connected to each of Y lines 104 and X lines 103 of the grid-based sensor 100.

During mutual capacitive detection one or the other of the X lines 103 and Y lines 104 is an active set of lines and the other one of the X lines 103 and Y lines 104 is a passive set of lines at one instant.

A typical grid sensor may have grid junctions spaced 4 mm apart or generally in a range of 01-10 mm apart.

A Response Function of a Grid Based Sensor to a Fine-Tipped Pen

An aspect of the disclosure includes measuring a response function of a single junction on a grid sensor, e.g. sensor 100 (FIG. 1) that defines a relative effect at a junction as a function of pen tip distance from that junction, and possibly also as a function of pen tip diameter, and pen tip shape. The response function is optionally stored for subsequent use in detecting the pen and calculating most-likely coordinates of the pen tip.

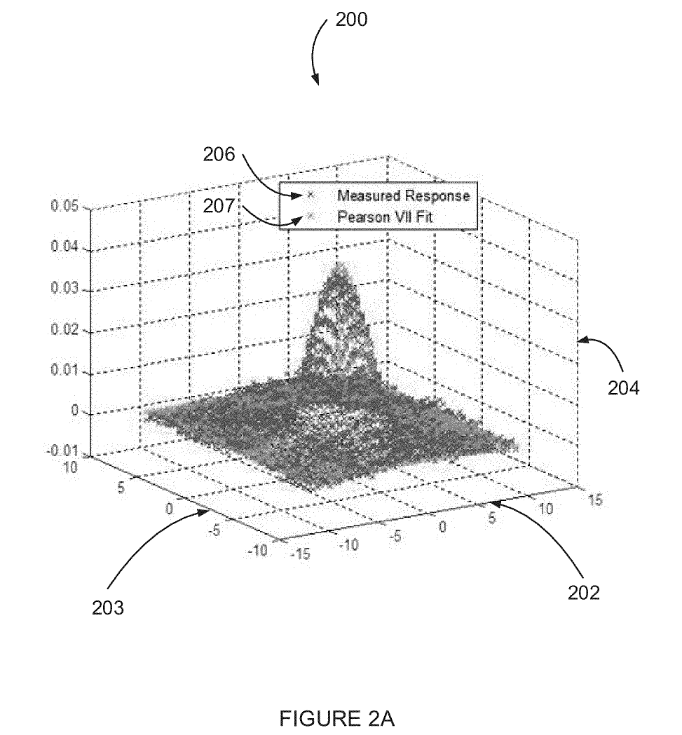

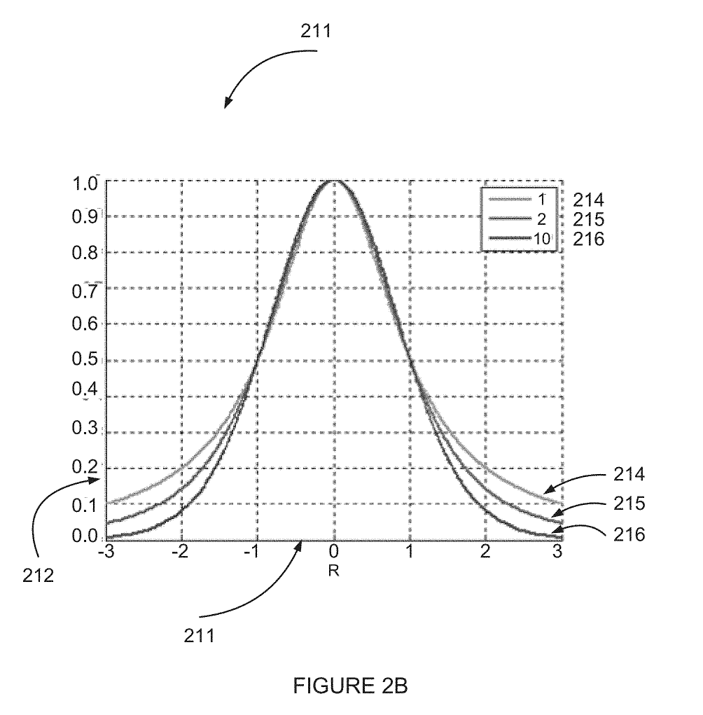

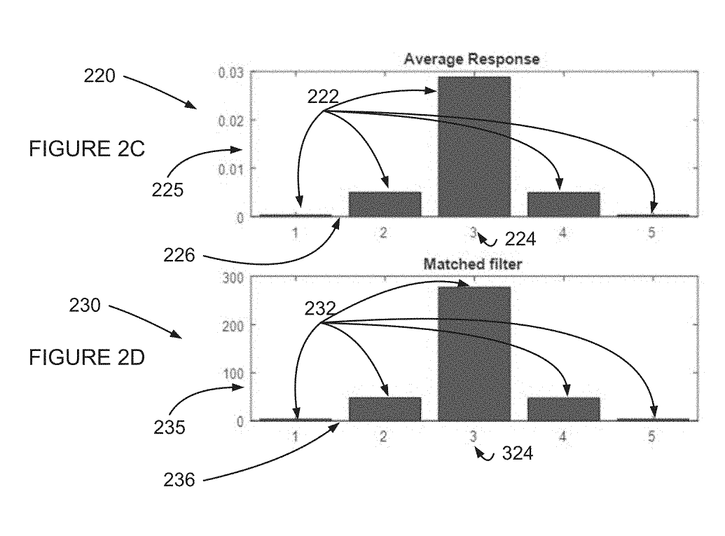

Reference is now made to FIG. 2A, which is an exemplary graph 200 of measured relative effects 206 from a junction of grid-based sensor as a function of distance and azimuth of a conductive tip from the junction according to an example embodiment of the disclosure.

The graph 200 of FIG. 2A includes an X axis 202 and a Y-axis 203 depicting distance from a specific junction of a grid sensor located at (0,0), units of millimeters, and a Z-axis 204 depicting relative amplitude.

FIG. 2A depicts the measured relative effect 206, and also an example response function 207, which fits the measured relative effect.

In some embodiments the response function Fᵣ may be modeled as a peak function named “Pearson VII” as follows:

$${F}_{r} ( P ) = {{I}_{max} ( \frac{{w}^{2}}{{w}^{2} + ( {2}^{1 / m} - 1 ) {\vert P \vert}^{2}} )}^{m} \qquad Equation 1$$

In Equation 1 w is a half width of the function Fᵣ, Imax is a peak and m is a parameter controlling a tail shape of the function, which models physical parameters of the pen tip and physical parameters of the touch screen. Optionally, P is a Mahalanobis distance. Typically, peak relative effect is detected when the conductive tip is on the junction and the relative effect diminishes with distance between the junction and the tip.

In some embodiments X and Y distances may optionally not be scaled equally, in which case an azimuthal dependence is effective in Equation 1, in addition to a radial dependence. In some such case the distance P may optionally be described as follows:

|P|=\sqrt{x²+ay²} Equation 2

Where ‘a’ is a measure of the function asymmetry between the X and Y axes.

FIG. 2A indeed depicts the Pearson VII response function as the example response function 207.

It is noted that the response function Fᵣ may be some other peak function such as a Gaussian function, or some other peak function which potentially provides a close fit to a measured response function.

It is noted that the response function is expected to depend on, by way of some non-limiting examples, a specific grid sensor, on a specific receiver impedance, and on pen type and pen tip shape.

In some embodiments the response function may optionally be kept normalized, that is, the maximum value, or some other representative value, is normalized to a specific value.

In some embodiments measurements from the grid sensor may be normalized, and optionally compared to the normalized response function.

In some embodiments the response function may be stored as a function and parameters describing the function, such as, by way of a non-limiting example, the parameters Imax, w, and m describe the Pearson VII response function fit to measured amplitudes of a specific grid sensor and a specific pen type and/or shape.

In some embodiments, the response function may be stored as a look-up table, e.g. an array of grid coordinates and calculated values of the response function.

In some embodiments, a separate response function is measured and optionally stored, for different pen tips, such as different pens, pencils, and so on.

Reference is now made to FIG. 2B, showing exemplary Pearson VII functions in two dimensions with different tail shapes in accordance with some exemplary embodiments of the present disclosure.

The graph 210 of FIG. 2B includes an X-axis 211 depicting distance from a peak of the function located at R=0, and a Y-axis 212 depicting amplitude in units normalized to 1.

FIG. 2B depicts a non-limiting example of the Pearson VII function for different values of m: a first line 214 depicting Pearson VII where m=1; a second line 215 depicting Pearson VII where m=2; and a third line 216 depicting Pearson VII where m=3. The different lines depicted in FIG. 2B exemplify different response functions, for example for different diameter tips. According to some exemplary embodiments, a peak function such as a Pearson VII is defined and applied to search for coordinates of a pen near selected junctions indicating possible presence of a passive stylus.

Selecting Junctions Indicating Possible Presence of a Passive Stylus

A signal produced by a fine tipped passive stylus may be small relative to background noise. In some exemplary embodiments, a weak relative effect is detected using a matched filter. The matched filter may be defined based on the estimated or measured response function and may represent an average response for tip locations in a plurality of different locations around a junction.

Reference is now made to FIGS. 2C and 2D, which are illustrations of an estimated average response and a matched filter respectively according to an example embodiment of the disclosure.

FIG. 2C depicts a non-limiting example graph 220 of values 222 of an average response function of a pen tip at 5 adjacent junctions located along one axis. Graph 220 depicts an exemplary average response function for a passive pen located around junction ‘3,’ e.g. between junction ‘2’ and ‘4.’ Amplitude is relative amplitude, e.g. relative to amplitude detected when there is no interaction with the digitizer sensor.

FIG. 2D depicts a matched function produced based on the values 222 depicted in FIG. 2C.

FIG. 2D depicts a non-limiting example graph 230 of values 232 of a matched filter at a non-limiting example length of 5 values. The matched filter of FIG. 2D was produced based on the average response function depicted in FIG. 2C.

FIG. 2D includes an X-axis 236 depicting distance, in units of junction-lengths, from a peak of the matched filter located at “3” 324, and a Y-axis 325 depicting a qualitative unit-less amplitude.

According to some exemplary embodiments, the matched filter is applied along one axis of the heatmap to detect junctions that may belong to a blob. A value above a threshold value indicates that the junction is part of a blob. Junctions identified in the heatmap are grouped into blobs. In some embodiments, the threshold may extend from 1.5% to 5%.

Large Blob Rejection

An aspect of the disclosure includes differentiating between small blobs that may be candidate blobs of passive pen and larger blobs due to finger, hand or wide tipped pen. A finger, or a large tipped pen, by way of some non-limiting examples, typically produce response signals from a large number of adjacent junctions, roughly corresponding to the area of the large tipped pen or the finger. Typically, larger blobs include enough information for detecting position and a maximum likelihood approach may not be required.

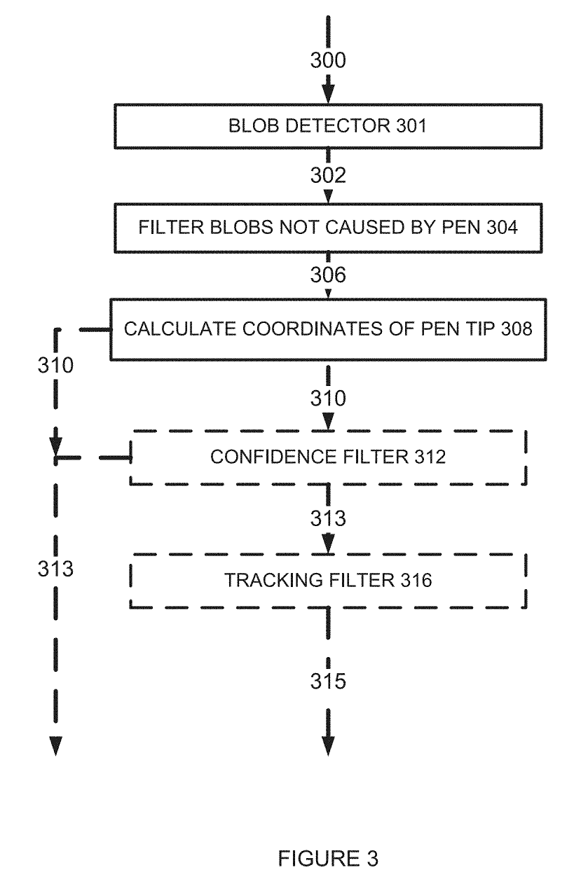

Reference is now made to FIG. 3, which is a simplified flow chart illustration of a method for filtering a list of blobs to reject blobs not caused by a pen, calculate coordinates of a tip of the pen, and report the coordinates, according to an example embodiment of the disclosure.

FIG. 3 depicts a heatmap 300 obtained from sampling output from a digitizer sensor. In some exemplary embodiments, filtering is applied on heat map 300 with a blob detector 301. The heatmap is optionally normalized. Blob detector 301 detects blobs that indicate possible locations of user interaction. Blob detector 301 typically identifies grid junctions in which values from heatmap passes a threshold. In some embodiments, the blob detector 301 includes a matched filter which optionally filters, allowing through electric signals which match an expected shape of a signal which is expected to be produced by a pen tip. An example embodiment of such a matched filter is described herein, e.g. herein above with reference to FIGS. 2C and 2D.

The blob detector 301 provides blobs 302 from the blob detector 301 to a blob-filtering unit 304 for filtering out blobs not likely to be caused by a fine tipped pen. Typically, blob filtering is based on size and shape of the blob. The blob-filtering unit 304 may use a method as described herein for performing the rejection. A fine-tipped passive pen typically produces a relative effect in the heatmap over a small area.

In some embodiments, a blob including a small number of junctions, such as 1×1, 1×2, 2×1, 2×2, and slightly larger area blobs may be considered as candidates for possibly containing a location of a fine tipped pen, while even larger blobs may optionally be rejected, as palm-rejection, finger-rejection, or large-tipped-stylus-rejection.

The blob-filtering unit 304 provides blobs 306 which are likely to be produced by a passive pen to a passive pen coordinate calculation unit 308. Unit 308 determines coordinates of a tip of the pen in the blob, e.g. center of mass of the blob based on maximum likelihood detection method as described herein. Coordinates of input from larger blobs may be detected by other methods known in the art. A confidence level is typically calculated for each pen location detected.

In some embodiments, the coordinate calculation unit 308 optionally provides a report of pen tip coordinates 310 to a host computer or an application running on the host.

In some embodiments, a confidence filter 312, accepts output of the coordinate calculation unit 308, and optionally filters the output of the coordinate calculation unit 308 based on a log likelihood cost function, for example as described herein in the section titled “Calculating likelihood for a point to be a location of a tip”.

The filtering optionally filters out coordinates which, after calculating the log likelihood cost function, do not pass a threshold which indicates likely belonging to an interaction with a passive pen. Typically, the filtering provides for differentiating between hover and touch of the passive pen. In some embodiments, the confidence filter 312 provides a report 313 of pen tip coordinates to a host computer or an application running on the host. In some embodiments, optionally, a tracking filter 316 is also applied to output of the confidence filter 312 that accepts or rejects detected coordinates based on history tracking of the passive pen. The tracking filter optionally sends out a report 315 following the filtering.

Calculating Coordinates of a Fine Tipped Stylus Touching a Grid Sensor at a Vicinity of a Grid Junction

In some embodiments a junction in a candidate blob which has a highest-amplitude signal is used as a start location for calculating a location of the fine-tipped stylus at higher-than-grid-cell resolution.

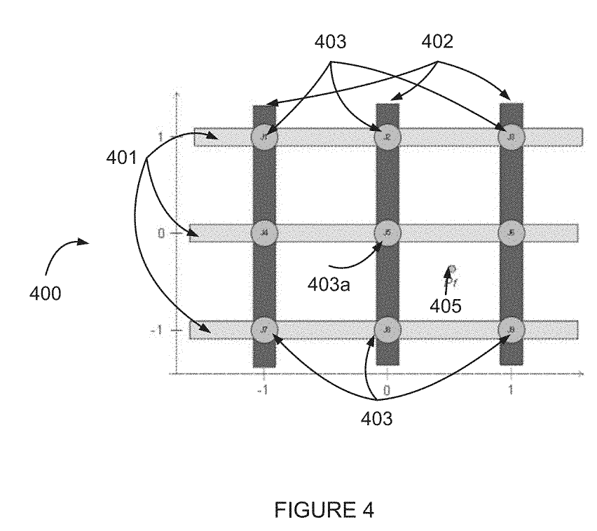

Reference is now made to FIG. 4, which is a simplified illustration 400 of junctions in a grid sensor and a location of a tip of a fine-tipped passive pen according to an example embodiment of the disclosure.

FIG. 4 depicts the simplified illustration 400 of a set of 9 junctions 403 at intersections of X-lines 401 and Y-lines 402, and a location Pf 405 of a tip of a fine-tipped passive pen. The 9 junctions are marked as 1, 2, 3, 4, 5, 6, 7, 8 and 9.

A set of N (e.g. N=9) signals is measured at the junctions, and Ji denotes an electric signal, optionally normalized, measured at an i'th junction. Noise, optionally independent and identically distributed (i.i.d.) white Gaussian noise, is also optionally modeled as added to the signals. Equation 3 below describes the measurements Ji:

Jᵢ=Fᵣ(Pᵢ−P_{f})+nᵢ Equation 3

Fr( ) denotes a response function and nᵢ denotes the additive noise. The position of the passive pen is denoted as a vector P_{f} and the position of an i'th junction is denoted as Pᵢ. Vector positions P_{f} and Pᵢ are relative to a central junction marked as 5, or 403a, also sometimes denoted as J5, such that P₅=[0,0]. In Equation 3 a single grid junction step is taken to be of unity length (i.e. P₆=[1,0] and P₇=[−1, ˜1]).

In some embodiments, location of the small passive pen tip is enabled at accuracy greater than a sensor pitch, or inter-junction distance.

In some embodiments, implementation of the disclosure as firmware of a grid-based sensor enables location of a passive pen at an accuracy, which enables using the small tip passive pen for writing on the grid-based sensor without requiring an active pen.

Calculating Likelihood for a Point to be a Location of a Tip

Assuming an identically distributed (i.i.d.) white Gaussian noise added to a signal of a pen tip, the following Equation describes a log-likelihood cost function L that a location Pf of the fine tipped pen causes a signal Ji at a junction Pi, where the fine-tipped pen is associated with a response function Fr.

L=Σᵢ[Jᵢ−Fᵣ(Pᵢ−P_{f})]² Equation 4

Minimizing cost L maximizes a probability of having correctly identified a location Pf.

Multi-Grid Search

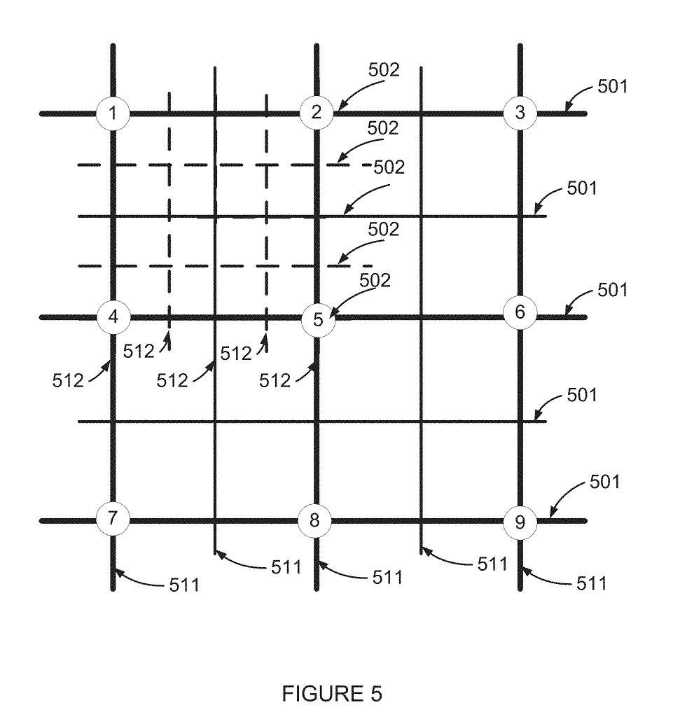

Reference is now made to FIG. 5, which is a simplified illustration of using progressively finer resolution grids to search for likely coordinates of a passive fine-tipped stylus touching a grid sensor according to an example embodiment of the disclosure.

FIG. 5 depicts X-lines 501 and Y-lines 511 of sides of a grid having at its center a grid junction P₅ 5, corresponding to junction position 5 403a of FIG. 4, surrounded by eight grid junctions P₁ 1 P₂ 2 P₃ 3 P₄ 4 P₆ 6 P₇ 7 P₈ 8 and P₉ 9 corresponding to junction positions 1, 2, 3 4, 5, 6, 7, 8, and 9 of FIG. 4.

The X-lines 501 and Y-lines 511 are at a finer resolution than the physical grid sensor. In FIG. 5, the X-lines 501 and Y-lines 511 are drawn at a resolution double the grid sensor resolution, however, even higher resolutions such as 3×, 4×, 5×, 10×, 20× and higher are contemplated. The higher resolutions are not drawn so as to keep the drawing less dense, for purpose of clarity of explanation.

Starting, by way of a non-limiting example, at grid junction P₅, likelihood of the tip at each of the junctions defined by crossing of the X-lines 501 and Y-lines 511 are determined.

By way of a non-limiting example, the grid cell most likely to contain the location of the tip is the top left grid cell. Based on the results, a finer grid is defined in the area depicting maximum likelihood, e.g. grid formed with X-lines 502 and Y-lines 512. Likelihood of the tip at each of the junctions defined by crossing of the X-lines 502 and Y-lines 512 are then determined. This process is repeated until coordinates of the tip are defined with a desired resolution.

A person skilled in the art may see that the sub-dividing and evaluating a most likely position may be repeated until some stop condition is reached.

In various embodiments the stop condition may be: a limit on the number of sub-divisions; reaching a desired accuracy of location of the pen tip; when the accuracy of the location of the pen tip is greater or equal to 0.1 mm; when the accuracy of the location of the pen tip is greater or equal to 25%, 15%, 10%, 5%, 2% or even 1% of a length of the grid cell side; and when a difference between likelihood of sub-grid cells containing a location of the tip is small, so that one sub-grid cell cannot be chosen over another based on likelihood.

Gradient Search

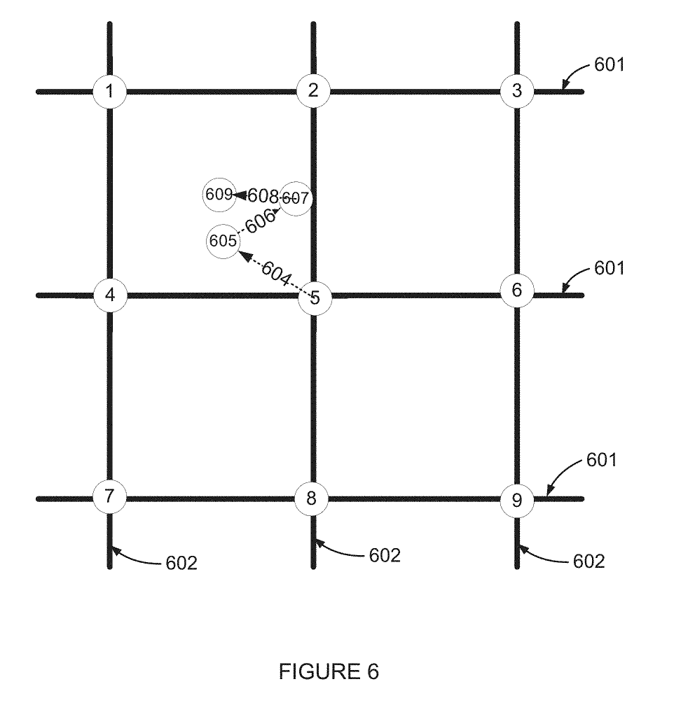

Reference is now made to FIG. 6, which is a simplified illustration of using gradient descent optimization method to search for likely coordinates of a passive fine-tipped stylus touching a grid sensor according to an example embodiment of the disclosure.

FIG. 6 depicts X-lines 601 and Y-lines 602 of sides of a grid having at its center a grid junction P₅ 5, corresponding to junction position 5 403a of FIG. 4, surrounded by eight grid junctions P₁ 1 P₂ 2 P₃ 3 P₄ 4 P₆ 6 P₇ 7 P₈ 8 and P₉ 9 corresponding to junction positions 1, 2, 3 4, 5, 6, 7, 8, and 9 of FIG. 4.

A log likelihood cost function, for example as described herein in the section titled “Calculating likelihood for a point to be a location of a tip”, is calculated for junction position P₅ 5 and at least one more of the neighboring junctions. In some embodiments, the log likelihood cost function is calculated for all the nine junctions P1-P9.

In some embodiments, starting at the central grid junction P₅ 5A a gradient descent direction 604 of the cost function is calculated, based on the log likelihood cost function values of the neighboring junctions Pᵢ, a step of length α₁ is calculated in the gradient descent direction 604, and coordinates of a candidate pen location 605 at the end of the step are calculated. This process may be repeated at candidate pen location 605 to reach candidate pen location 607 and at candidate pen location 607 to reach candidate pen location 609.

Calculating the gradient descent direction and coordinates of a new candidate pen location may optionally be repeated until an end condition is reached.

In some embodiments, the step lengths αᵢ are equal, optionally set to a desired resolution or location accuracy.

In some embodiments, the step lengths αᵢ start larger, e.g. half a grid spacing, and gradually shrink, e.g. by half at each iteration.

In some embodiments, the stop condition is a limit on the number of iterative gradient descent searches.

In some embodiments, the stop condition is when a candidate location P^{d}f is at a minimum cost.

In some embodiments, the stop condition is when a candidate location P^{d}f is at a minimum cost and the sub-grid division reaches a desired accuracy of location of the pen tip.

In some embodiments, the stop condition is when the accuracy of the location of the pen tip is greater or equal to 0.1 mm.

In some embodiments, the stop condition is when the accuracy of the location of the pen tip is greater or equal to 25%, 15%, 10%, 5%, 2% or even 1% of a length of the grid cell side.

In some embodiments, the stop condition is when a difference between likelihood of candidate locations is small, so that a cost of one candidate location cannot be determined to be statistically significantly lower than another candidate location.

In some embodiments, the stop condition is met when a maximum allowable iteration steps. (e.g. Max Step ˜10) is reached.

Symmetry Issues

In some embodiments, by way of a non-limiting example when a non-symmetric grid is used or when the grid's response is asymmetric, an asymmetric response function is used, by way of a non-limiting example an elliptically symmetrical response function.

An example of a method for dealing with an asymmetric response function is described above with reference to Equation 2.

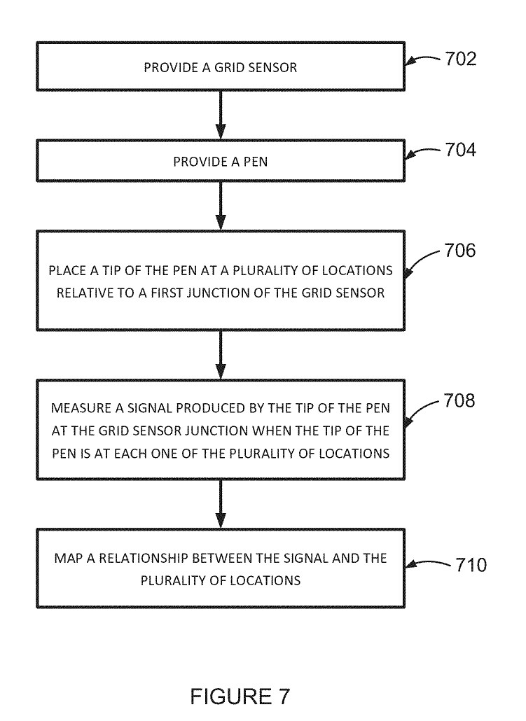

Reference is now made to FIG. 7, which is a simplified flow chart illustration of a method for mapping a relationship between a signal and a location of a pen tip touching a sensing surface of a grid based digitizer sensor according to an example embodiment of the disclosure.

The method of FIG. 7 includes: providing a grid sensor (702); providing a pen (704); placing a tip of the pen at a plurality of locations relative to a first junction of the grid sensor (706); measuring a signal produced by the tip of the pen at the grid sensor junction when the tip of the pen is at each one of the plurality of locations (708); and mapping a relationship between the signal and the plurality of locations (710).

According to an aspect of some embodiments of the present disclosure there is provided a method including receiving an output signal from a grid based digitizer sensor to detect outputs from junctions of the sensor, identifying, based on the output signal, an area on the sensor likely to include output caused by touch of a passive pen tip, applying a maximum likelihood cost function at points within the area to identify likely coordinates of the passive tip on the digitizer sensor, and selecting most likely coordinates for the location of the passive pen tip, wherein the most likely coordinates are defined based on the output signal in the area and on a pre-defined response function, wherein the response function relates an output signal from a junction to distance of the passive tip from the junction.

According to some embodiments of the disclosure, the area is defined as an area including no more than one or two adjacent grid junctions providing an output signal larger than a defined threshold.

According to some embodiments of the disclosure, the coordinates include coordinates which are between junctions of the digitizer sensor.

According to some embodiments of the disclosure, the area is defined as a specific junction providing output beyond a defined threshold and up to eight junctions surrounding the specific junction.

According to some embodiments of the disclosure, the identifying, based on the output signal, further includes filtering the output signal using a matched filter.

According to some embodiments of the disclosure, the selecting most likely coordinates includes using a gradient descent search of the maximum likelihood cost function calculated for a plurality of coordinates in the area, searching for coordinates that have a maximum likelihood.

According to some embodiments of the disclosure, selecting most likely coordinates includes using an iterative search for successively higher resolution sub-grids of the grid based digitizer sensor.

According to some embodiments of the disclosure, further including calculating likelihood cost function values to the most likely coordinates, and filtering to remove coordinates which have cost function values less than a threshold.

According to some embodiments of the disclosure, further including providing the most likely coordinates to a tracking filter for tracking the passive pen tip.

According to an aspect of some embodiments of the present disclosure there is provided apparatus including memory configured to store pre-defined response function, wherein the response function relates an output signal from a digitizer sensor junction to distance of a passive pen tip from the junction, and a circuit configured to detect outputs from digitizer sensor junctions, identify, based on the outputs, an area on the digitizer sensor likely to include output caused by touch of a passive pen tip, apply a maximum likelihood cost function at points within the area to identify likely coordinates of the passive pen tip on the digitizer sensor, and select most likely coordinates for the location of the passive pen tip, wherein the most likely coordinates are defined based on the output signal in the area and the response function.

According to some embodiments of the disclosure, the memory is configured to store more than one response function each corresponding to a defined shape of the passive pen tip.

According to some embodiments of the disclosure, the circuit applies matched filtering to detect candidate areas of the sensor likely to include output caused by touch of a passive pen tip.

According to some embodiments of the disclosure, the circuit is configured to use a gradient search for a minimum of the log maximum likelihood cost function.

According to some embodiments of the disclosure, the circuit is configured to use an iterative search with successively higher resolution sub-grids of portions of the area.

According to some embodiments of the disclosure, the circuit is further configured to select coordinates including coordinates which are between junctions of the digitizer sensor.

According to some embodiments of the disclosure, the circuit is further configured to calculate likelihood cost function values to the most likely coordinates, and filter to remove coordinates which have cost function values less than a threshold.

According to some embodiments of the disclosure, the circuit is further configured to provide the most likely coordinates to a tracking filter for tracking the passive pen tip.

According to some embodiments of the disclosure, the outputs are detected based on self-capacitive detection or based on mutual capacitive detection.

According to an aspect of some embodiments of the present disclosure there is provided a method for mapping a relationship between a signal and a location of a pen tip touching a sensing surface of a grid based digitizer sensor, the method including (a) providing a grid sensor, (b) providing a pen, (c) placing a tip of the pen at a plurality of locations relative to a first junction of the grid sensor, (d) measuring a signal produced by the tip of the pen at the grid sensor junction when the tip of the pen is at each one of the plurality of locations, and (e) mapping a relationship between the signal and the plurality of locations.

According to some embodiments of the disclosure, further including storing at least one parameter describing the tip of the pen selected from a group consisting of an identifier describing a material of which the pen tip is included, and an identifier describing geometric properties of the pen tip.

Certain features of the examples described herein, which are, for clarity, described in the context of separate embodiments, may also be provided in combination in a single embodiment. Conversely, various features of the examples described herein, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

What is claimed is:

1. A method comprising:
receiving an output signal from a grid based digitizer sensor to detect outputs from junctions of the sensor;
identifying, based on the output signal, an area on the sensor likely to include output caused by touch of a passive pen tip;
applying a maximum likelihood cost function at points within the area to identify likely coordinates of the passive tip on the digitizer sensor; and
selecting most likely coordinates for the location of the passive pen tip, wherein:
the most likely coordinates are defined based on the output signal in the area and on a pre-defined response function, wherein the response function relates an output signal from a junction to distance of the passive tip from the junction.

2. The method of claim 1, wherein the area is defined as an area including no more than one or two adjacent grid junctions providing an output signal larger than a defined threshold.

3. The method of claim 1, wherein the coordinates include coordinates which are between junctions of the digitizer sensor.

4. The method of claim 1, wherein the area is defined as a specific junction providing output beyond a defined threshold and up to eight junctions surrounding the specific junction.

5. The method of claim 1, wherein the identifying, based on the output signal, further comprises filtering the output signal using a matched filter.

6. The method of claim 1, wherein the selecting most likely coordinates comprises using a gradient descent search of the maximum likelihood cost function calculated for a plurality of coordinates in the area, searching for coordinates that have a maximum likelihood.

7. The method of claim 1, wherein selecting most likely coordinates comprises using an iterative search for successively higher resolution sub-grids of the grid based digitizer sensor.

8. The method of claim 1, and further comprising calculating likelihood cost function values to the most likely coordinates, and filtering to remove coordinates which have cost function values less than a threshold.

9. The method of claim 1, and further comprising providing the most likely coordinates to a tracking filter for tracking the passive pen tip.

10. Apparatus comprising:
memory configured to store pre-defined response function, wherein the response function relates an output signal from a digitizer sensor junction to distance of a passive pen tip from the junction; and
a circuit configured to:
detect outputs from digitizer sensor junctions;
identify, based on the outputs, an area on the digitizer sensor likely to include output caused by touch of a passive pen tip;
apply a maximum likelihood cost function at points within the area to identify likely coordinates of the passive pen tip on the digitizer sensor; and
select most likely coordinates for the location of the passive pen tip,
wherein the most likely coordinates are defined based on the output signal in the area and the response function.

11. The apparatus of claim 10, wherein the memory is configured to store more than one response function each corresponding to a defined shape of the passive pen tip.

12. The apparatus of claim 10, wherein the circuit applies matched filtering to detect candidate areas of the sensor likely to include output caused by touch of a passive pen tip.

13. The apparatus of claim 10, wherein the circuit is configured to use a gradient search for a minimum of the log maximum likelihood cost function.

14. The apparatus of claim 10, wherein the circuit is configured to use an iterative search with successively higher resolution sub-grids of portions of the area.

15. The apparatus of claim 13, wherein the circuit is further configured to select coordinates including coordinates which are between junctions of the digitizer sensor.

16. The apparatus of claim 13, wherein the circuit is further configured to calculate likelihood cost function values to the most likely coordinates, and filter to remove coordinates which have cost function values less than a threshold.

17. The apparatus of claim 13, wherein the circuit is further configured to provide the most likely coordinates to a tracking filter for tracking the passive pen tip.

18. The apparatus of claim 13, wherein the outputs are detected based on self-capacitive detection or based on mutual capacitive detection.

19. A method for mapping a relationship between a signal and a location of a pen tip touching a sensing surface of a grid based digitizer sensor, the method comprising:
(a) providing a grid sensor;
(b) providing a pen;
(c) placing a tip of the pen at a plurality of locations relative to a first junction of the grid sensor;
(d) measuring a signal produced by the tip of the pen at the grid sensor junction when the tip of the pen is at each one of the plurality of locations; and
(e) mapping a relationship between the signal and the plurality of locations.

20. The method of claim 19, and further comprising storing at least one parameter describing the tip of the pen selected from a group consisting of:
an identifier describing a material of which the pen tip is comprised; and
an identifier describing geometric properties of the pen tip.
